(19) United States
(12) Patent Application Publication
(10) Pub. No.: US 2010/0241939 A1
(43) Pub. Date: Sep. 23, 2010

(54) PHOTO ALBUM

(76) Inventor: Dalit Rozen-Atzmon, Hadera (IL)

Correspondence Address: DEBORAH A. GADOR, P.O. BOX 4133, GANEL TIKVA, 55900, IL

(21) Appl. No.: 12/295,728

(22) PCT Filed: Mar. 20, 2007
(86) PCT No.: PCT/IL2007/000361

§ 371 Date: Oct. 2, 2008

(30) Foreign Application Priority Data
Apr. 3, 2006 (IL) 174750

(51) Int. Cl. G06F 3/14; G09G 5/00

(52) U.S. Cl. 715/202; 345/641

(57) ABSTRACT

An electronic photo album providing a plurality of templates, each for a different occasion or style of occasion or type of album. Each template is a computer program including a plurality of pages, at least one page having a background design, music and transition effects suitable for the subject matter of that particular album, and at least one page having one or more frames for photos or other visual mementos. The program further includes instructions for arranging the photographs or visual mementos in the template for displaying the photos singly or in groups, one after the other. The pages can be displayed in sequence automatically, with pre-selected time intervals between pages, or manually. The templates can be filled and/or sold via the Internet, downloaded to a personal computer for filling, burned on DVD's or other storage devices. According to one embodiment, the photos are uploaded to a central server, where the album is assembled and may be stored on a memory device or downloaded back to the user's computer.

### FIELD OF THE INVENTION

The present invention relates to photo albums, in general and, in particular, to virtual and electronic photo albums for electronic photos.

### BACKGROUND OF THE INVENTION

Photo albums for collecting photographs have been known almost as long as there have been cameras for taking photographs. These are generally books in which individual photographs can be mounted, generally with adhesive or between layers of plastic sheeting.

With the advent of the Internet, virtual photo albums have been developed which permit a person to upload electronic photographs onto a website and permit sharing, so that friends and relatives can have access to the photographs. A background or decorative frame may be provided on which the photos are viewed.

There also are known computer program products which permit a person to form a virtual photo album by selecting a background, selecting music files for background music, selecting decorative motifs and artistic frames, selecting where to place each photo and in what position (i.e., permitting photos to be rotated, flipped, adjusting transparency, etc.), selecting transition effects between photographs, and so on, so as to permit viewing of the photos as a series of slides. These programs are complex and expensive, and generally do not provide optimum results.

Accordingly, there is a long felt need for an electronic photo album which is easy to use, requiring few decisions by the user, and it would be very desirable to have such an album which is pre-organized according to professional standards.

### SUMMARY OF THE INVENTION

There is provided according to the present invention an electronic photo album including a template for a particular subject matter, the template including pre-selected visual elements and a plurality of frames for receiving electronic photographs or other visual mementos, and computer program means for inserting the electronic photographs and mementos in the frames provided in the template, for display.

The pre-selected visual elements may include a pre-selected background illustration around the frame and/or pre-selected transition effects between display of the frames, as well as decorative pages that can serve as chapter heads or dividers.

According to a preferred embodiment of the invention, the photo album further includes pre-selected audio elements for playing during display of said the album , such as background music or other sounds.

Preferably, the pre-selected visual and audio elements are selected or prepared by professionals in their fields, i.e., graphic artists and musicians.

According to one embodiment of the invention, the electronic photo album is stored in a memory device for display in a memory device reader.

There is also provided in accordance with the present invention an electronic photo album including a storage device, a pre-selected cover for the storage device, possibly indicating the subject matter of the electronic photos in the album, and at least one template stored in the storage device, each template including a plurality of frames for receiving a plurality of photographs or other visual mementos arranged in a selected order. The template is adapted to automatically upload the photographs and insert each photograph in an appropriate available frame in consecutive order, and display them.

There is further provided in accordance with the present invention a method for preparing an electronic photo album including preparing a template for a particular subject matter, the template including pre-selected visual elements and a plurality of frames for receiving electronic photos and other visual mementos; and storing the template for later filling with electronic photos for display. The template may be prepared by selecting a cover design, a plurality of pages with frames for receiving photos or mementos, transition effects between pages of frames, a background illustration, and/or background music or other sounds, and storing the template for later filling with photos.

There is also provided a computer program product for preparing an electronic photo album. The computer program product includes at least one template for a particular subject matter, the template including a plurality of frames for receiving electronic photos and pre-selected visual elements and program means for inserting electronic photographs in the frames in the template, for display.

### BRIEF DESCRIPTION OF THE DRAWINGS

The present invention will be further understood and appreciated from the following detailed description taken in conjunction with the drawings in which:

FIG. 1 is a schematic illustration of a first page of an electronic photo album constructed and operative in accordance with one embodiment of the present invention;

FIG. 2 is a schematic illustration of an exemplary page of an electronic photo album constructed and operative in accordance with an alternative embodiment of the present invention;

FIG. 3 is an example of a transition effect according to one embodiment of the invention;

FIG. 4 is an example of a transition effect according to another embodiment of the invention; and

FIG. 5 is an exemplary cover illustration of an electronic photo album according to another embodiment of the invention.

### DETAILED DESCRIPTION OF THE INVENTION

The present invention relates to electronic photo albums which are individualized for specific occasions and which provide a professional finished product that can be filled in the home by an amateur user. This is accomplished by providing a plurality of templates, each for a different occasion or style of occasion or type of album. Each template is a computer program including a plurality of pages, at least one page having a background design, music and transition effects suitable for the subject matter of that particular album, and at least one page having one or more frames for photos or other visual mementos. The program further includes instructions for arranging the photographs or visual mementos in the template for displaying the photos singly or in groups, one after the other. The pages can be displayed in sequence automatically, with pre-selected time intervals between pages, or manually. Preferably, the templates are designed and assembled by professionals in their fields, such that the overall template has a professional quality. The user merely must arrange his or her photos in the desired order, and upload them into the template, where they are automatically arranged within the various frames. Thus, filling the album is very fast and easy. The templates can be filled and/or sold via the Internet, downloaded to a personal computer for filling, burned on DVD's or other storage devices either empty or full, or marketed in any other fashion, and are very user-friendly. According to one embodiment, the photos are uploaded to a central server, where the album is assembled and may be stored on a memory device or downloaded back to the user's computer.

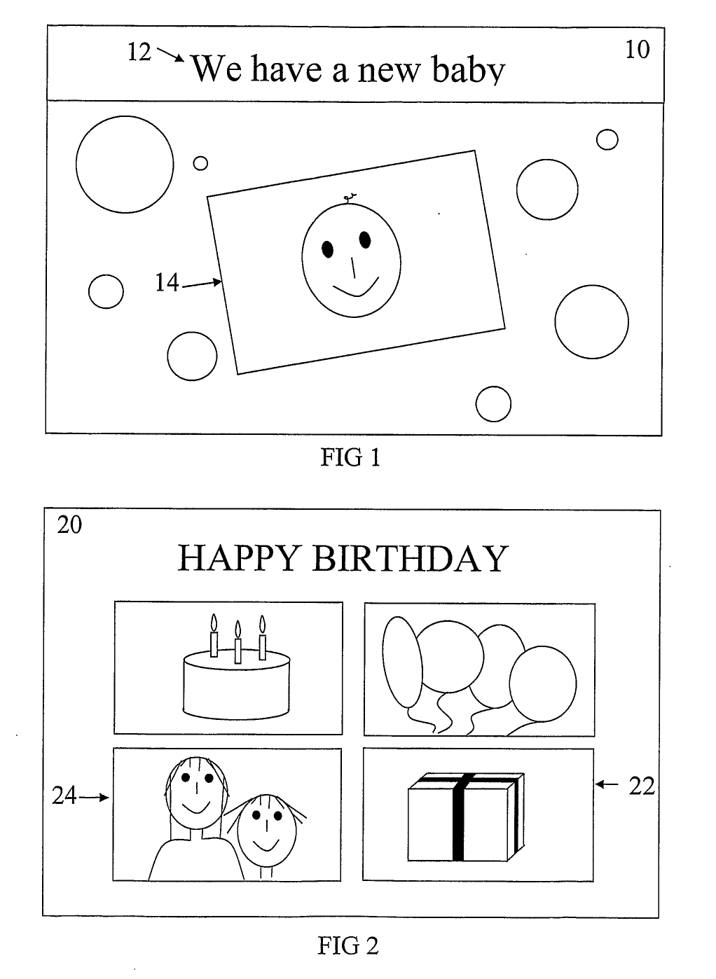

Referring now to FIG. 1, there is shown a schematic illustration of a cover page 10 of an electronic photo album constructed and operative in accordance with one embodiment of the present invention. Cover page 10 serves as the cover of the album, and includes a decorative frame 12 inscribed with a title or description of the album, such as A Baby is Born, Ruthie's 13^{th} birthday, Our Vacation etc. An additional cover illustration or background illustration may be provided, if the designer desires. The cover page 10 preferably includes a location 14 adapted to receive an electronic photograph or other electronic visual memento selected by the user which characterizes the album for the user.

Interior pages of the album include a plurality of frames for a pre-selected number of pictures and divider pages between groups of photos. For example, as shown in FIG. 2, a schematic illustration of an exemplary page 20 of a photo album constructed and operative in accordance with an alternative embodiment of the present invention, frames 22 for four photos 24 are provided on each page. It will be appreciated that the graphic designer and the program in the template will determine how many frames to place on each page, preferably between 1 and 4, depending partially on the orientation of the various photos. The total number of photos which can be inserted in the album is preferably defined in the template, for example 100, 200, 500, and the user will purchase or select an album of the appropriate size. Some of the pages may include animation, in addition to background illustrations. Other pages may be provided in the template with prepared titles, for example, in a baby album, to provide a particular place for an ultrasound picture, or to permit entry by the user of personal data, such as the date the baby first crawled, or his or her first word.

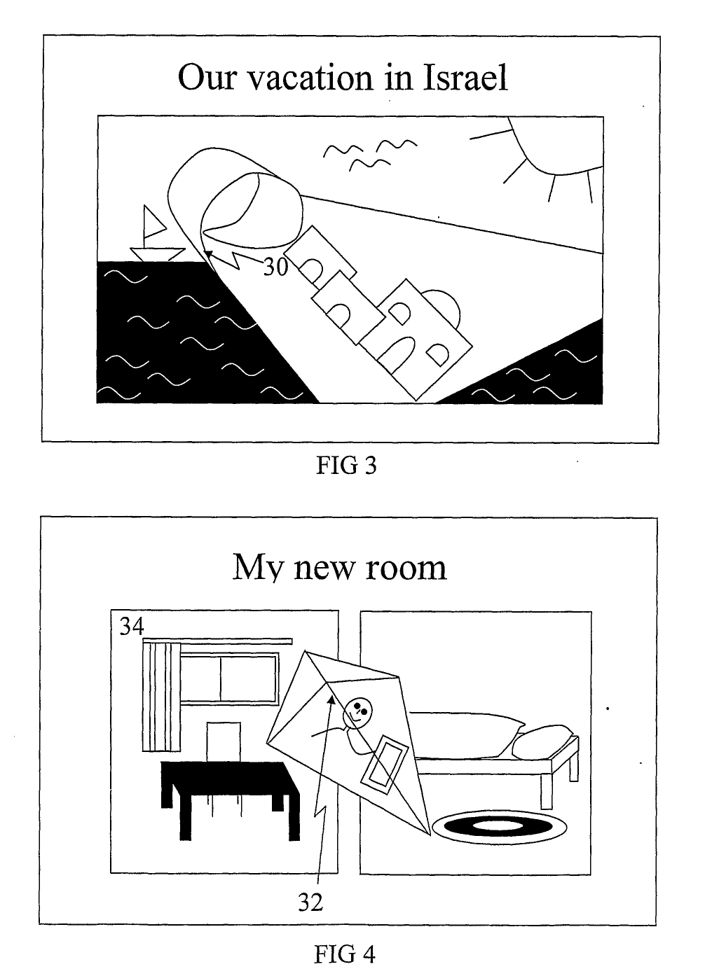

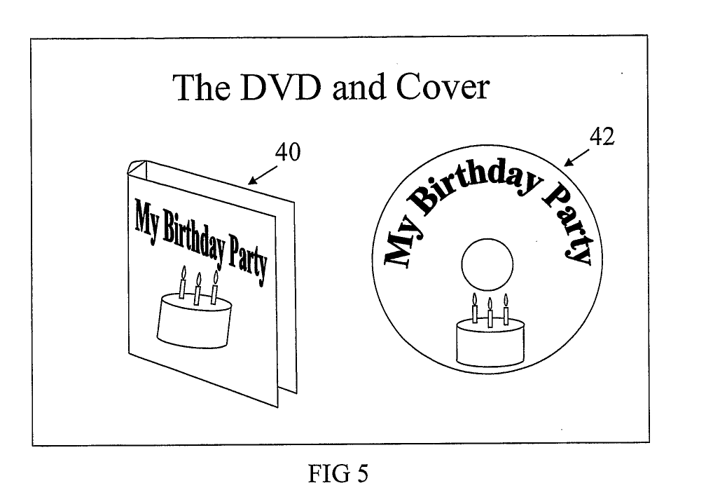

Suitable transition effects, appropriate for the particular subject matter of the album, are provided for the transitions between pages. These may be the same or different throughout the album. A couple of non-limiting examples are shown in FIGS. 3 and 4. FIG. 3 illustrates a roll-up page 30, with the following page already appearing behind it, while FIG. 4 illustrates a page folding to a paper airplane 32 before it disappears before the next slide 34. Alternatively, for example, the page can turn into a balloon, which floats away.

Preferably, the album is divided into chapters, in which different groups of photographs can be inserted. The user can provide a title or other written matter at the start of each chapter. Decorative divider pages may be provided, if desired, which do not necessarily hold photos.

Appropriate music will be pre-selected for the album, depending upon the occasion commemorated in the album. The music will play automatically as the photos are displayed. Preferably, a professional musician or composer will select or prepare the music. For marketing purposes, several different styles of templates may be provided for each type of event.

It is a particular feature of the present invention that the templates can be designed by experts in their fields, so as to provide a substantially professional product, regardless of the artistic taste or talent of the user. This is not possible with conventional electronic albums, which either are very simple sharing programs, or which require the user to select substantially every detail for his or her album.

Preferably, the order of the photos is selected by the user. For example, the template may include the possibility of dragging and dropping photos from one position to another in the list of photos to be inserted into the album, or browsing through saved photos and copying them to compile the list. If desired, capability of rotation of the photo through 90° may also be provided. In addition, the user may insert personal text or comments relating to each photo. Alternatively, instead of only conventional electronic photos, it may be possible to insert into the album video clips or video movies and/or any other medium holding electronic visual memementos.

The photo album of this embodiment of the invention is designed for preparation on a personal computer or on a dedicated server having access via the Internet, and can be stored in a memory device for replaying as desired, whether on a computer or in any suitable memory device player. One example of a particularly suitable memory device at present is a DVD or CD ROM, on which the album can be burned for later display on a CD player or computer. However, alternatively, the album may be stored in any other suitable memory device. If desired, an album can be prepared via the Internet using photographs on the user's computer, and then stored by the server on the Internet, or on a DVD or other storage medium, and mailed to the user. These albums can then be shared online and viewed by other viewers, as known, or the user can request prints of photographs or portions of the album.

There is also provided in accordance with the invention a shelf product, namely an electronic photo album which can be purchased and given as a gift, either empty or full. One example of such a product is shown in FIG. 5. In FIG. 5, there is shown a designer cover 40 and a disk 42 for preparing and storing an electronic album for a particular occasion, here illustrated as a birthday album. Cover 40 includes a pre-selected cover illustration and title indicating the subject matter of the photos in the album. The cover 40 is preferably created by a graphic designer. Disk 42 stores an electronic photo album including a template having a plurality of frames for receiving a plurality of electronic photographs and/or video clips, etc., and displaying them as a series of photos or as a movie. Each picture can be displayed for any pre-selected period of time. According to one embodiment of the invention, each page is displayed for about 5 seconds. At this speed, the display would be about 17 minutes, if there are 500 photos.

According to one embodiment of the invention, the template is self-executing and opens when the disk is inserted into a computer, providing instructions for introducing the photos into the album. The disk may include software for communicating with the central server so as to permit assembly of the album in the server. Alternatively, the disk may include the template for assembly of the album on the user's computer. Or, according to another embodiment, part of the program may reside on the server while another part is stored on the disk or other memory device sold in the store. The template will already include transition effects between pages of frames, background illustrations as necessary, and background music to be played while the photos are displayed.

The album on disk 42 may be packaged in any desired manner. According to one embodiment of the invention, the disk and cover are packaged in a transparent plastic holder, as are conventional DVD's. Alternatively, the album on disk can be packaged in a hard cover, like a book. The cover illustration and title would be printed on the hard cover, and the disk would fit inside a plastic sleeve or box inside the hard cover. The cover could be held closed by a tie, or in any other manner.

Each template is implemented in a computer program having pre-selected data. The program provides for the user means for uploading electronic photographs in an order selected by the user. The program is preferably located in a central server accessible over the Internet or other network, although, as stated above, all or part of the program can be located on the memory device, such as a DVD. The template includes fixed elements, including background illustrations, background music, and transition effects between pages of photographs, as well as elements which can be changed by the user, namely the order of the photographs, their orientation, and descriptive titles or other written matter. Chapter headings or other division of the mementos into groups can also be added by the user.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. An electronic photo album comprising:
a template for a particular subject matter, the template including
a plurality of frames for receiving electronic photographs and visual mementos; pre-selected visual elements; and
a computer program for inserting electronic photographs or visual mementos in said frames in the template, for display.

2. The photo album of claim 1, wherein said pre-selected visual elements include a pre-selected background illustration around said frame.

3. The photo album of claim 1, wherein said pre-selected visual elements include pre-selected transition effects between displays of said frames.

4. The photo album of claim 1, further comprising pre-selected audio elements for playing during display of the album.

5. The photo album of claim 4, wherein said audio elements include pre-selected background sound.

6. An electronic photo album according to claim 8, further comprising:
a template pre-selected and adapted for a particular subject matter, said template including:
a plurality of pages, at least one of said pages including at least one frame for receiving an electronic photograph or visual memento;
a pre-selected background illustration around said frame,
pre-selected background sound; and
pre-selected transition effects between said pages;
all suited for said subject matter, and
means for inserting electronic photographs in said frames in the template for display.

7. The photo album according to claim 6 wherein the electronic photo album is stored on a memory device for display in a memory device reader.

8. An electronic photo album according to claim 1, further comprising:
a storage device,
a pre-selected cover for the storage device, and
said template stored in said storage device, including a plurality of frames for receiving a plurality of photographs or visual mementos arranged in a selected order, said template being adapted to automatically upload said photographs or mementos and insert each photograph or memento in an available frame in consecutive order, and display them.

9. The photo album according to claim 8, wherein said pre-selected cover indicates subject matter of photos in the album.

10. A method for preparing an electronic photo album comprising:
preparing at least one template for a particular subject matter, each said template including
a plurality of frames for receiving electronic photos; and
pre-selected visual elements; and
storing said at least one template for later filling with electronic photos for display.

11. The method according to claim 10, wherein said step of preparing a template includes selecting a cover design.

12. The method according to claim 10, wherein said step of preparing a template includes selecting a plurality of pages with frames for receiving electronic photos.

13. The method according to claim 10, wherein said step of preparing a template includes selecting transition effects between pages of frames.

14. The method according to claim 10, wherein said step of preparing a template includes selecting background illustrations around said frames.

15. The method according to claim 10, wherein said step of preparing a template includes selecting background music for playing together with display of the album.

16. The method according to claim 15, wherein said background music is selected or composed by a professional musician.

17. The method according to claim 10, wherein said pre-selected visual elements are selected or prepared by professional graphic artists.

18. The method according to claim 10, wherein said pre-selected visual elements are selected or prepared by professional graphic artists.

19. A computer program product for preparing an electronic photo album comprising:
a computer useable medium having computer program logic recorded thereon for preparing a template for a particular subject matter, said computer program logic comprising:
pre-selected visual elements for said template; and
a plurality of frames for receiving electronic photos; and
control logic that enables a processor to store said template for later filling with electronic photographs or visual mementos and for displaying said photographs or visual mementos.
